(19) United States
(12) Patent Application Publication
(10) Pub. No.: US 2012/0109369 A1
(43) Pub. Date: May 3, 2012

(54) TANGIBLE STORAGE MEDIA ACCESS MANAGEMENT

(75) Inventor: Lyndon Rey Paluga, Cebu City (PH)

(73) Assignee: NCR Corporation, Duluth, GA (US)

(21) Appl. No.: 12/915,276

(22) Filed: Oct. 29, 2010

(51) Int. Cl. G06F 17/00; B65G 59/00; B65D 83/08

(52) U.S. Cl. 700/236; 221/1; 221/120; 700/232

(57) ABSTRACT

Apparatus, systems, and methods operate to receive a request to access a selected one of a plurality of tangible storage media held in substantially rectangular tangible storage media storage racks. Each rack has first and second opposing sides substantially parallel to a media insertion axis of the rack in a horizontal plane. Operations may include rotating a vertical spindle about its longitudinal axis, the spindle coupled to the plurality of racks with a corresponding plurality of arms having substantially equal length. Rotation provides access to grippers located to extract the selected media along the media insertion axis. A side axis coinciding with the first opposing side of a first one of the racks intersects the second opposing side of a second one of the racks, the first one of the racks being adjacent the second one of the racks. Additional embodiments are disclosed.

### BACKGROUND

Kiosks to distribute tangible storage media, such as Digital Video Disks (DVDs), provide a convenient way for consumers to access selected media. However, the widespread acceptance of these kiosks faces some challenges, due to the space occupied by the kiosk, the potential for accidentally ejecting the media within the kiosk (and possibly damaging the media) during media handling operations, and the time consumers must wait to receive media when the kiosk has only one POD (where the display, media access port, card reader, and other user interface devices are placed) that can be used to distribute the media.

### SUMMARY

In various embodiments, mechanisms and techniques for managing access to tangible storage media are presented. For example, in some embodiments, methods include receiving a request to access a selected one of a plurality of tangible storage media held in a plurality of substantially rectangular tangible storage media storage racks. Each of the racks may have first and second opposing sides substantially parallel to a media insertion axis of the rack in a horizontal plane. Additional activities include rotating a vertical spindle having a longitudinal axis substantially perpendicular to the horizontal plane and coupled to the plurality of racks with a corresponding plurality of arms having substantially equal length. Rotation can provide access to a gripper located to extract selected media along the media insertion axis. The racks are positioned so that a side axis coinciding with the first opposing side of a first one of the racks intersects the second opposing side of a second one of the racks, the first one of the racks and the second one of the racks comprising an adjacent pair of racks.

In some embodiments, an apparatus comprises a plurality of substantially rectangular tangible storage media storage racks, each of the racks having first and second opposing sides substantially parallel to a media insertion axis of the rack in a horizontal plane. The apparatus may further comprise a vertical spindle having a longitudinal axis substantially perpendicular to the horizontal plane and coupled to the plurality of racks with a corresponding plurality of arms having substantially equal length. A side axis coincident with the first opposing side of a first one of the racks intersects the second opposing side of a second one of the racks, with the first one of the racks and the second one of the racks comprising an adjacent pair of racks.

In some embodiments, a system comprises a server and multiple apparatus communicatively coupled to the server. Additional embodiments will be described in the Drawings and Detailed Description that follow.

### BRIEF DESCRIPTION OF THE DRAWINGS

FIG. 1 is a perspective, exploded view of an apparatus, comprising a tangible storage media distribution kiosk, according to various embodiments of the invention.

FIG. 2 is a top view of selected portions of an apparatus, comprising a tangible storage media distribution kiosk having multiple PODs, according to various embodiments of the invention.

FIG. 3 is a top plan view of arrangements of tangible storage media storage racks, according to various embodiments of the invention.

FIG. 4 is a perspective view of selected portions of an apparatus, comprising a tangible storage media distribution kiosk, according to various embodiments of the invention.

FIG. 5 is a perspective view of selected portions of an apparatus, comprising a tangible storage media distribution kiosk having multiple PODs, according to various embodiments of the invention.

FIG. 6 is a perspective view of an apparatus, with multiple PODs and open access doors, according to various embodiments of the invention.

FIG. 7 is a perspective view of an apparatus, with multiple PODs and closed access doors, according to various embodiments of the invention.

FIG. 8 is a block diagram of apparatus and a system that can be used to manage access to tangible storage media, according to various embodiments of the invention.

FIG. 9. is a flow diagram of methods to manage access to tangible storage media, according to various embodiments of the invention.

FIG. 10 is a block diagram of an article of manufacture, including a specific machine, according to various embodiments of the invention.

### DETAILED DESCRIPTION

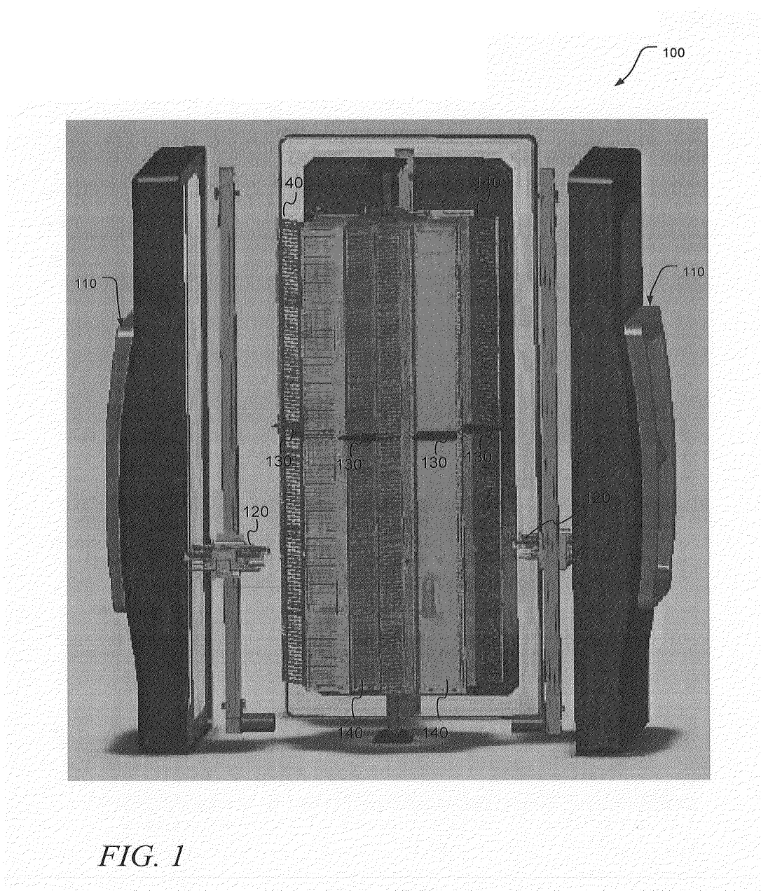

FIG. 1 is a perspective, exploded view of an apparatus 100, comprising a tangible storage media distribution kiosk, according to various embodiments of the invention. Here it can be seen that the apparatus 100 has three PODs 110. As will be shown in more detail in other figures, each POD 110 provides a consumer interface sub-assembly, with a display, card reader, media access port, and information entry pad (e.g., personal identification number (PIN) pad). Multiple grippers 120 are used to access and dispense the tangible storage media 130 held in tangible storage media storage racks 140. In many embodiments, a gripper 120 is provided for each POD 110.

For the purposes of this document, “tangible storage media” refers to both the media itself (e.g., a CD-ROM or DVD, some other type of optical disc, as well as flash drives and other nontransitory media), and the media 130 in combination with a physical transport case designed to carry, house, and protect the media 130 when the media 130 is dispensed to consumers.

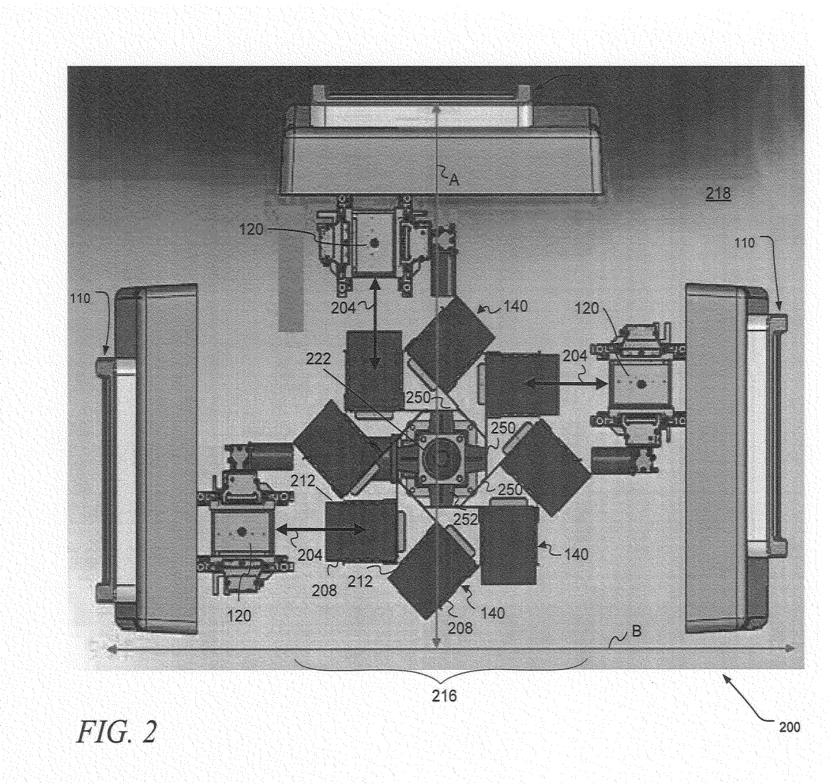

FIG. 2 is a top view of selected portions of an apparatus 200, comprising a tangible storage media distribution kiosk having multiple PODs, according to various embodiments of the invention. Here three PODs 110 and three corresponding grippers 120 can be seen. A gripper 120 may comprise a single axis robotic grasping device to insert and extract tangible storage media from the racks 140, and to dispense the media directly to a port provided by the POD 110, or to a dispensing system that delivers the extracted medium to the port.

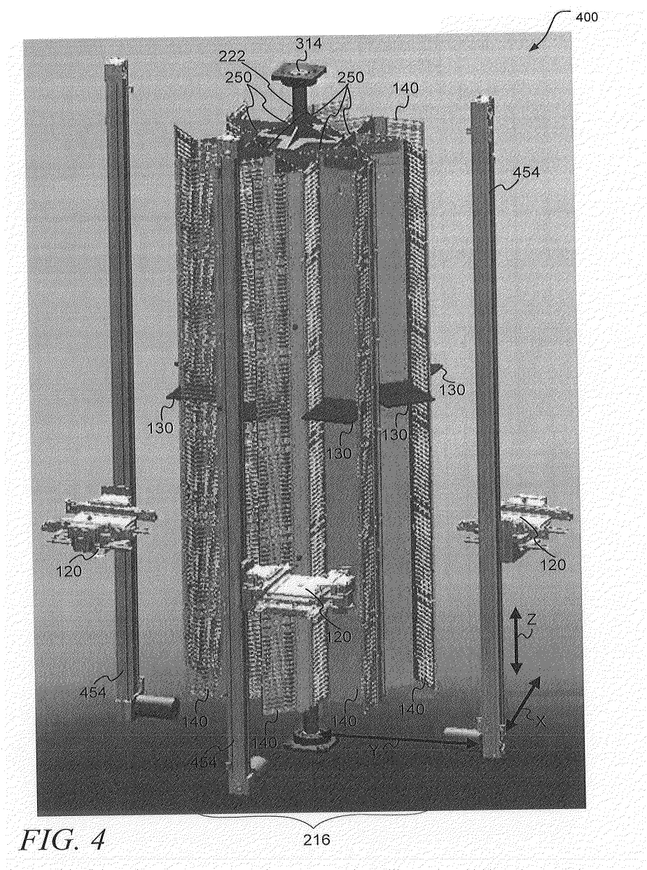

Media insertion and extraction occur along the media insertion axis 204, which is disposed between first and second opposing sides 208, 212 of the rack 140 accessible to the gripper 120. In some embodiments, the media insertion axis 204 is disposed approximately equidistant from the first and second opposing sides 208, 212. Thus, the gripper 120 moves in the horizontal plane 218, along the media insertion axis 204. As will be shown in FIG. 4, the gripper 120 can be mounted to a track to enable travel in the vertical direction.

To reduce the amount of floor space occupied by the apparatus 200, it is useful to reduce the distances A and B shown in the figure. The can be accomplished by arranging the racks 140 so as to reduce the size of the carousel 216 (combination of racks 140 and spindle 222) in a unique manner. The reduction in carousel size results in a commensurate reduction in the length of the arms 250 that attach the spindle 222 to the racks 140.

In some embodiments, as shown in FIG. 2, some of the arms 250 are attached directly to the spindle 222, and some of the arms 250 are attached indirectly to the spindle 222. That is, when the arm 250 of one rack 140 is attached to the arms 250 of two adjacent racks 140, alternating ones of the arms 250 can be attached directly to the spindle 222, perhaps using an octagon, square, or cross-shaped attachment element (shown) 252 having the spindle 222 at its center. This arrangement creates a larger effective spindle diameter, for greater mechanical strength.

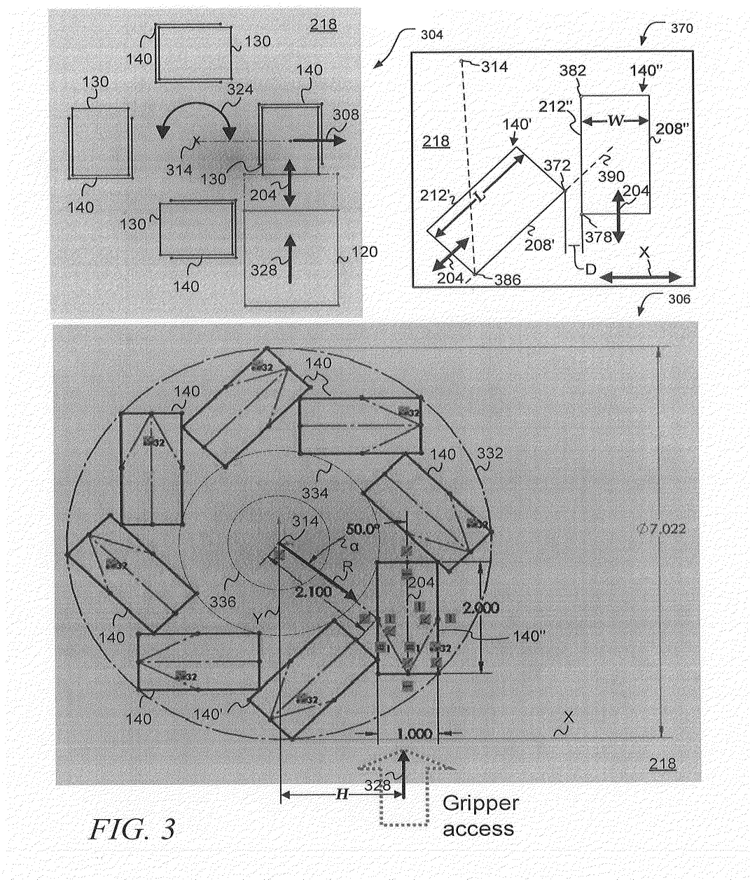

FIG. 3 is a top plan view of arrangements 304, 306, 370 of tangible storage media storage racks 140, according to various embodiments of the invention. In some embodiments, the racks 140 are positioned so that the media insertion axis 204 is substantially perpendicular to the axis of centrifugal force 308 when the spindle rotates about the longitudinal axis 314, in the direction of the arrows 324. With this arrangement 304, when the rack 140 is rotated about the longitudinal axis 314 of the spindle 222, the centrifugal force does not tend to expel the media 130 from the rack 140. Here only one gripper 120 is shown, with clear access to the rack 140 along the media insertion axis 204.

For the purposes of this document, elements that are “substantially equal” have the same measurement in at least one direction, within about 5% of each other. For example, three arms may be substantially equal in length if their relative lengths measure 0.95, 0.98, and 1.00. “Substantially parallel” or “substantially perpendicular” means being within about two degrees of being perfectly parallel or perfectly perpendicular, respectively, out of an included angle between lines, axes, and/or line segments. For example, two axes are substantially parallel if the angle included between them is plus or minus two degrees. Two axes are substantially perpendicular if the angle included between them is 92 degrees, or 88 degrees.

The arrangement 304 of four racks 140 provides four columns of media. For increased capacity, more racks 140 may be used.

For example, arrangement 306 shows eight racks 140 arranged about the spindle 222. Each of the racks 140 in this arrangement 306 has been arbitrarily assigned a size of Width=1 unit, and Length=2 units. In this case, when the spindle 222 rotates, the axis of centrifugal force 308 does not coincide with the media insertion axis 204. Given their proximity to the spindle 222, if the racks 140 in arrangement 306 were positioned in the same way as the racks 140 of arrangement 304 (where the insertion axis 204 is perpendicular to the axis of centrifugal force 308), there would be insufficient room for a gripper 120 to access the media, because adjacent racks 140 would interfere.

As shown in arrangement 306, the X and Y axes define the horizontal plane 218. The X axis is tangent to a first circle 332 defined by the outer periphery of the racks 140. The Y axis is perpendicular to the X axis, and intersects the longitudinal axis 314 of the spindle 222.

In arrangement 306, the grippers 120 are horizontally offset along the X axis by a distance H, from an origin or zero point defined by the center of the spindle 222 (i.e, the longitudinal axis 314), which lies on the Y axis in the horizontal plane 218. In some embodiments, the Y axis is parallel to the media insertion axis 204 and the centerline 328 of the gripper 120 when the gripper 120 is positioned to access tangible storage media that is held in the rack 140. In this position, the centerline 328 of the gripper 120 is substantially coincident with the media insertion axis 204.

In this orientation, in a first example, the centerline 328 of the gripper 120 intersects the first circle 332 at two points, but does not intersect a second circle 334 defined by the inner periphery of the racks 140 (shown in arrangement 306). In a second example, the centerline 328 of the gripper 120 intersects both the first circle 332 and the second circle 334 at two points. In a third example, the centerline 328 of the gripper 120 also intersects both the first circle 332 and the second circle 334 at two points. However, the centerline 328 of the gripper 120 does not intersect a third circle 336, defined by a radius that is approximately 50% of the length of the radius R of the second circle 334.

Referring now to FIGS. 2 and 3, it can be seen that when the gripper is positioned as noted in the first, second, or third example described with respect to FIG. 3, the centerline 328 is offset from the center of the carousel 216 (see FIG. 2), which is the longitudinal axis 314. Thus, it can be located closer to the carousel 216 in the Y direction. This permits the POD that corresponds to the gripper 120 to be located closer to the carousel as well, reducing the amount of floor space occupied by the apparatus 200.

As shown in arrangement 306, the length of the arm 250 is a function of the relative width of the rack (1.00) and the angle α (shown as 50 degrees), where the angle α is the included angle between the axis of centrifugal force (here, along radius R) and the media insertion axis 204. In many embodiments the angle α is between about 45 degrees and about 60 degrees. In some embodiments the angle α is between about 45 degrees and about 75 degrees.

The diameter of the first circle 332 is a function of the length of the arm 250 (which is dependent on the width of the rack (set here to a relative value of 1.00), and the angle α). The length of arm 250 is also dependent on how much space the gripper 120 uses in the horizontal direction. This is because, although the gripper 120 does not move in the horizontal direction (i.e., along the X axis), its width during the activity of accessing media in a particular rack 140 may interfere with adjacent racks 140 if they are placed too close to the spindle 222. In most embodiments, the racks 140 are disposed approximately equally about the circle 332 at an angular separation distance of about 360 degrees divided by the number of racks 140. Thus, with eight racks 140, as shown in arrangement 306, the angular displacement of the racks 140 about the circle 332 is about 45 degrees.

The arrangements 300, 306, 370 illustrate how tangible storage media 130 can be more easily retained in the racks 140 during rotation of the spindle 222. The more closely the angle α approximates 90 degrees, the lesser will be the centrifugal force to expel the media 130 from the racks 140.

FIG. 4 is a perspective view of selected portions of an apparatus 400, comprising a tangible storage media distribution kiosk, according to various embodiments of the invention. In this case, a carousel 216 with eight racks 140 is shown. Three grippers 140 are shown, each of which can independently and simultaneously travel in the vertical or Z axis direction along a different track 454 when the spindle 222 is rotating. The X, Y, and Z axes shown in the figures herein form part of a conventional three-axis, mutually orthogonal coordinate system.

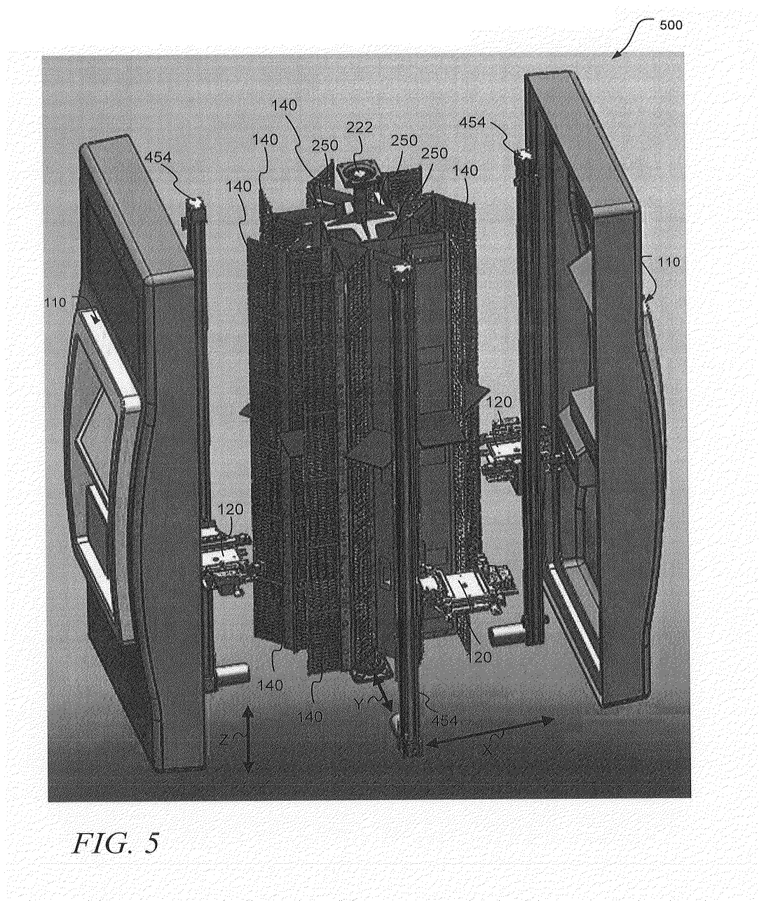

FIG. 5 is a perspective view of selected portions of an apparatus 500, comprising a tangible storage media distribution kiosk having multiple PODs 110, according to various embodiments of the invention. As shown in this figure, multiple PODs 110 can be positioned so there is a one-to-one correspondence between a POD 110 and a gripper 120. One of the PODs 110 is not shown in this figure, so as not to obscure the view of the internal arrangement of the racks 140, which corresponds to arrangement 306 of FIG. 3.

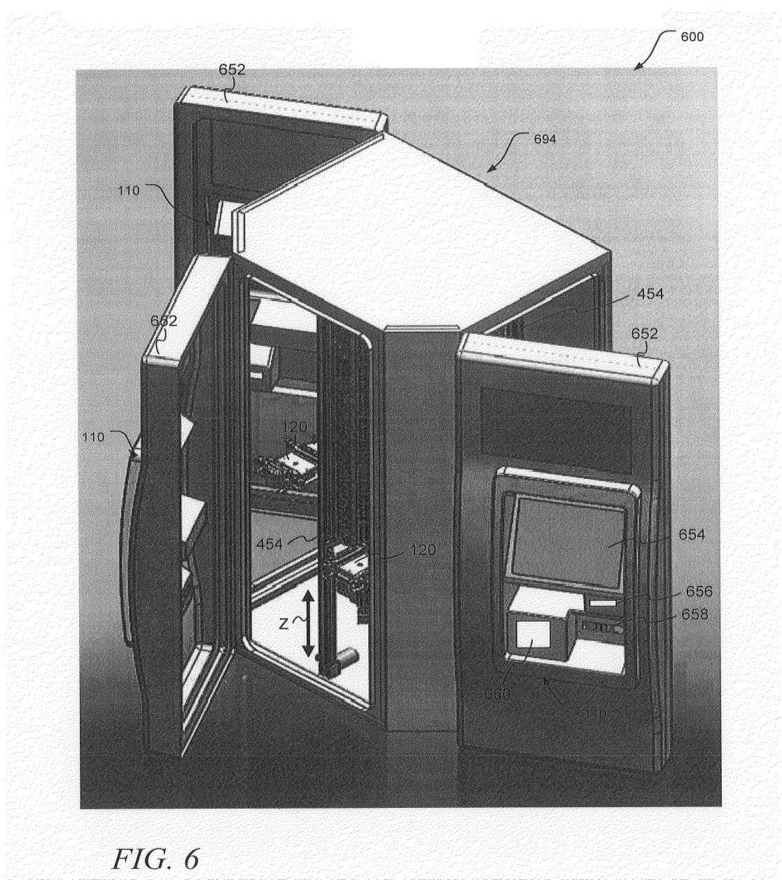

FIG. 6 is a perspective view of an apparatus 600, with multiple PODs 110 and open access doors 652, according to various embodiments of the invention. Here it can be seen that three PODs 110 are provided, one for each of three tracks 454, which are in turn attached to three grippers 120. While only two grippers 120 and two tracks 454 are seen in FIG. 6, all three grippers 120 and their corresponding tracks 454 are shown in FIGS. 4-5. Each POD 110 provides a user interface sub-assembly with a display 654, card reader 656, media access port 658, and information entry pad 660 (e.g., personal identification number (PIN) pad).

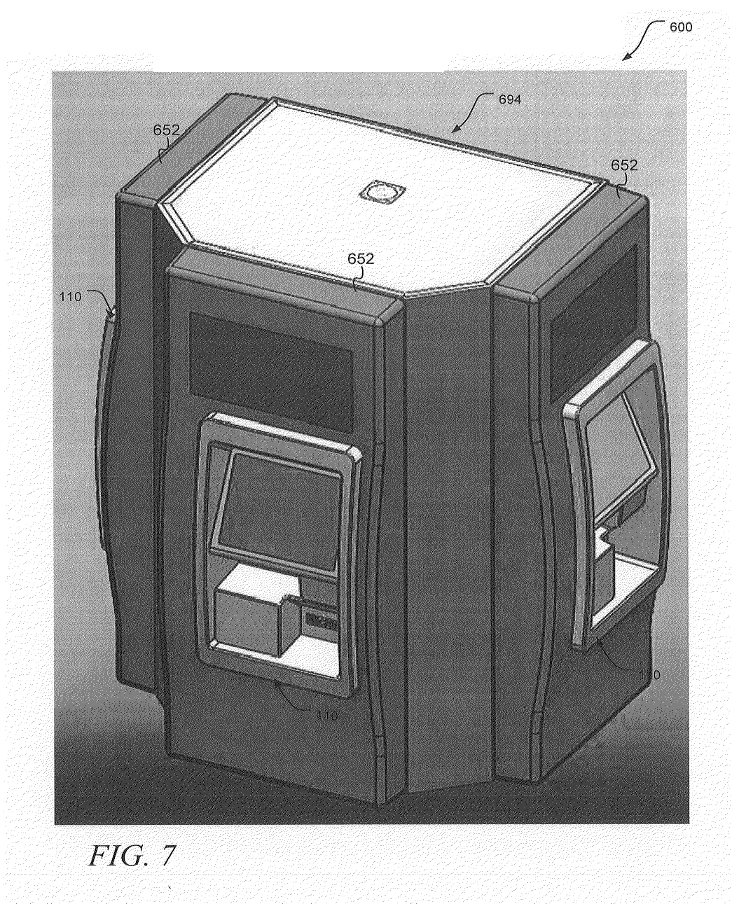

FIG. 7 is a perspective view of an apparatus 600, with multiple PODs 110 and closed access doors 652, according to various embodiments of the invention. The multiple-POD apparatus 600, with a rotating carousel of uniquely positioned racks, using individual POD grippers, is a simplified solution to some of the challenges mentioned previously. Alternatives include an XYZ robot, which is more complicated, and slower. This is because the robot moves in three axes around the carousel, and is supplied as a single robot, rather than three independently moving grippers, mounted to tracks, which each move along a single axis.

Thus, when each POD 110 is associated with a gripper, three consumers may access the apparatus 600 at the same time. As the racks rotate about the spindle, each gripper can be positioned to a pre-selected position along a track in the (vertical) Z axis at substantially the same time. That is, when the rack rotates, all grippers can simultaneously pre-position themselves in the vertical direction. Once the rack stops rotating, the grippers can move to extract the media in a horizontal direction. The kiosk may be programmed to provide variation in media titles for each rack column, so that the amount of rack rotation used to access a selected title will be reduced. In this way, the rack rotates only when the media title selected is not found among the titles in the rack currently facing the gripper for a particular POD (e.g., none of the 120 DVDs in rack column match a title selected by the consumer). Other advantages will become apparent as the various embodiments are now described in detail.

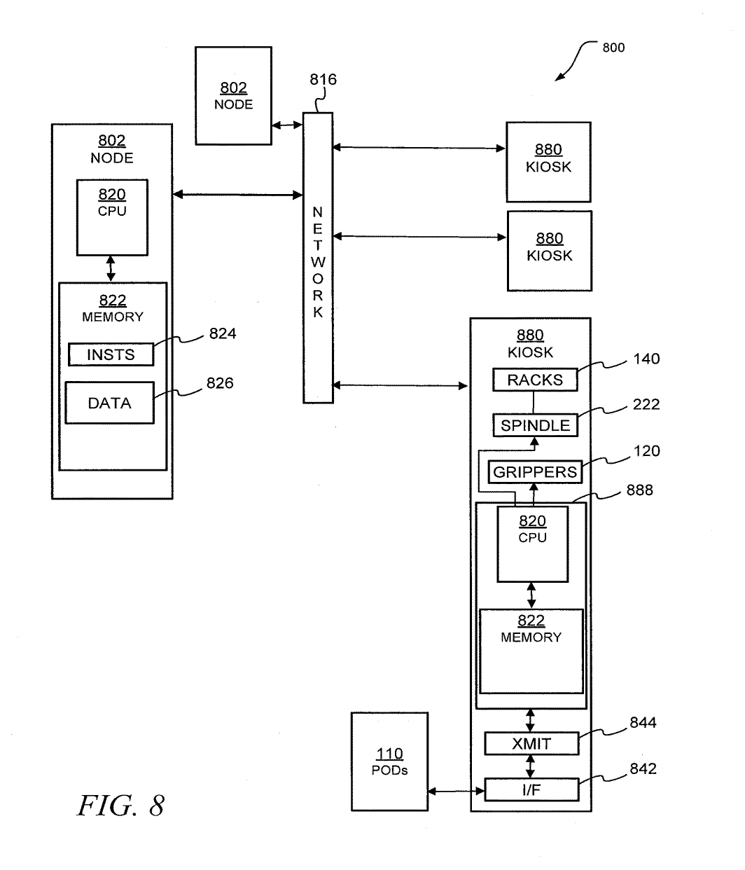

FIG. 8 is a block diagram of apparatus 880 and a system 800 that can be used to manage access to tangible storage media, according to various embodiments of the invention. The apparatus 880 may comprise a multi-POD kiosk in some embodiments. Thus, the apparatus 880 may comprise any one or more of the components shown in the apparatus 100, 200, 400, 500, 600, 700 shown in FIGS. 1-2, and 4-7, respectively; or the arrangements 304, 306, 370 shown in FIG. 3.

Referring now to FIGS. 2, 3, 6, and 8, it can be seen that an apparatus 880 may comprise racks 140 that are coupled to a spindle 222 with arms 250, forming a carousel 216 defined in part by a spatial relationship between the opposing sides of adjacent racks 140. A circle 332 of a selected diameter (defined by the outer periphery of the racks 140) may have a radius selected to provide a minimum clearance distance D along the X axis in the horizontal plane 218, between a first end 372 of the first opposing side 208′ of the first one of the racks 140′ (having a second opposing side 212′), and a second end 378 of the second opposing side 212″ of the second one of the racks 140″ (having a first end 382 of the second opposing side 212″, and a first opposing side 208″), given the angle α, and the width W and length L of the racks 140′, 140″. This radius can thus be defined by the distance from the longitudinal axis of the spindle 222 to a second end 386 of the first opposing side 208′. That is, the length L and width W of the rectangular racks 140, and the desired angle α between the axis of centrifugal force 308 and the media insertion axis 204, along with the number of racks 140 in the carousel 216, determines the diameter of the circle 332, and thus, the length of the arms 250. In some embodiments, the length L and the width W may be substantially the same (i.e., the racks 140 may take the form of squares, as well as rectangles). Thus, additional embodiments may be realized.

For example, and apparatus 880 may comprise a plurality of substantially rectangular tangible storage media storage racks 140′, 140″, each of the racks having first 208′, 208″ and second 212′, 212″ opposing sides, respectively, substantially parallel to a media insertion axis 204 of the rack 140 in a horizontal plane 218. “Substantially rectangular” with respect to a rack 140 means opposing sides of a rack 140 are substantially parallel to each other, and each of the opposing sides are substantially perpendicular to adjacent sides of the same rack.

The apparatus 880 may further comprise a vertical spindle 222 having a longitudinal axis 314 substantially perpendicular to the horizontal plane 218 and coupled to the plurality of racks 140 with a corresponding plurality of arms 250 having substantially equal length.

In some embodiments, an axis 390 coincident with the first opposing side 208′ of a first one of the racks 140′ intersects the second opposing side 212″ of a second one of the racks 140″, where the first one of the racks 140′ and the second one of the racks 140″ comprise an adjacent pair of racks within the carousel 216.

The racks 140 can be configured to hold rectangular media cases, well-known to those of ordinary skill in the art and shown in U.S. Pat. No. 7,774,233, assigned to the same assignee as this disclosure, and incorporated herein by reference in its entirety. Thus, the apparatus 880 may have racks 140 that are configured to hold multiple ones of tangible storage media 130 housed in substantially similar individual rectangular transport cases.

To help retain the media 130 in the racks 140, the media insertion axis 204 and the axis of centrifugal force 308 are normally not aligned when then spindle 222 rotates. Thus, the axis of centrifugal force 308 defined by rotation of the vertical spindle 222 and the horizontal plane 218 is not collinear with the media insertion axis 204.

The racks 140 may be rigidly attached to the arms 250. Thus, in some embodiments, each one of the racks 140 is rigidly attached to a corresponding one of the arms 250. When rigid attachment is used, the racks 140 maintain a fixed orientation with respect to each other and to the spindle 222, as well as to the axis of centrifugal force 308, during media handling operations.

The apparatus 880 may include multiple grippers 120 to extract or insert the media into the racks 140. Thus, the apparatus 880 may comprise multiple grippers 120 having a travel direction (e.g., the Z axis) substantially parallel to the longitudinal axis 314 of the spindle 222, wherein the grippers 120 are configured to grasp individual ones of tangible storage media 130 held in the racks 140.

It is noted that the grippers 120 may form part of a transfer system to transfer media 130 between the racks 140 and another mechanism (a hand-off or transfer location on the shelf and/or a second gripper/robot, as shown in U.S. Patent Publication No. 2009/0276085, assigned to the same assignee as this disclosure, and incorporated herein by reference in its entirety) to a discharge chute and/or to a port that provides the consumer with physical access to the media 130, as is well-known to those of ordinary skill in the art. Other mechanisms may be used to transfer the media 130 from the gripper 120 to a physical access port on the face of a kiosk, for example. In some embodiments, the grippers 120 transfer the media 130 directly from the racks 140 to a physical access port 658 forming part of a POD 110.

Multiple grippers 120 can travel in the vertical direction (i.e., Z axis) substantially simultaneously with each other, and while the spindle 222 is rotating. Thus, each of the grippers 120, when retracted (e.g., moved as far away from the carousel 216 as possible, to provide the maximum rotational freedom for the carousel 216), can move in the travel direction (e.g., Z axis) at substantially the same time, in conjunction with continuous rotation of the spindle 222 about the longitudinal axis 314. For the purposes of this document, “substantially the same time” means at least one gripper 120 can move in the vertical direction (Z axis) at the same time as another gripper 120 is moving in the vertical direction, and that both grippers 120 can move in the vertical direction at the same time the carousel 216 is rotating, when the grippers are retracted.

Each gripper 120 may be associated with a user interface station, such as a POD 110, or any one or more components of a POD 110. Thus, an apparatus 880 may comprise multiple user interface stations, wherein each one of the user interface stations is operable to control one of the grippers 120 to grasp individual ones of the tangible storage media 130 when operational power is applied to the user interface stations and the grippers 120.

The user interface stations may be associated with media access portals. Thus, the apparatus 880 may comprise multiple access doors 652 attached to a housing 694 surrounding the racks 140, wherein each one of the access doors 652 corresponds to one of the grippers 120 and provides a port 658 with physical access to individual ones of the tangible storage media 130 that have been extracted by a corresponding one of the grippers 120.

The racks 140 may be arranged so that only rotation of the spindle 222 is needed to give grippers 120 access to the media 130, and the grippers 120 may have substantially simultaneous access once rotation is complete. Thus, in some embodiments, all of the grippers 120 can be located to substantially simultaneously grasp individual ones of tangible storage media 130 held in the racks 140 facing individual ones of the grippers 120, when the spindle 222 is not rotating.

The racks 140 may be disposed such that adjacent racks 140′, 140″ have a fixed angular relationship around the spindle 222. Thus, in some embodiments, each of the racks 140 is fixedly spaced apart from adjacent racks 140 by approximately the same distance in the horizontal plane 218 around the longitudinal axis 314, so that the racks 140 maintain a fixed physical relationship in space, with each other and the spindle 222, as the spindle 222 rotates.

The apparatus 880 may comprise multiple user interface stations, wherein each station can control rotation of the spindle 222, and one gripper 120. Thus, the apparatus 880 may comprise multiple user interface stations, wherein each one of the user interface stations is operable to control rotation of the vertical spindle 222 and a single gripper 120 to grasp individual ones of the tangible storage media 130 stored in the racks 140 when operational power is applied to the user interface stations and the grippers 120.

The apparatus 880 may include a transmission module 844 to transmit inventory status of the media 130 held within the apparatus 880 to another location, such as a server. Thus, the apparatus 880 may comprise a transmission module 844, including a wireless transmission module, to transmit inventory status to a server, the inventory status identifying tangible storage media 130 retained in the racks 140, and/or removed from, or placed into the racks 140 by the grippers 120.

The apparatus 880 may comprise a multiple-port kiosk. Thus, the apparatus 880 may be housed in a kiosk housing 694 configured to provide physical access via multiple ports 658 to selected tangible storage media 130 held in the racks 140 and dispensed in return for monetary consideration. Still further embodiments may be realized.

For example, a system 800 may comprise one or more processing nodes 802, one or more processors 820, multiple memories 822, multiple apparatus 880, and/or a network 816. The processing nodes 802 may comprise a client, a server, or some other networked processing node. The memories 822 may include instructions 824 and data 826 (e.g., inventory status) to be operated on by the processor 820. The processors 820 and memories 822 may be included in a processing element 888, which may comprise a node 802, a motherboard, a printed circuit card coupled to a backplane, etc.

The processing nodes 802 may comprise physical machines or virtual machines, or a mixture of both. The nodes 802 may also comprise networked entities, such as servers and/or clients. In some implementations, the operations described previously can occur entirely within a single node 802. The nodes 802 may thus comprise any one or more components of the apparatus 880.

Thus, in some embodiments, the system 800 may comprise multiple instances of the apparatus 880. The system 800 might also comprise a cluster of nodes 802, including physical and virtual nodes.

The nodes 802 may exist as a device embedded within another structure (e.g., as an embedded device), or as a regular desktop or laptop computer that includes a terminal to show the activities conducted while the node 802 is active.

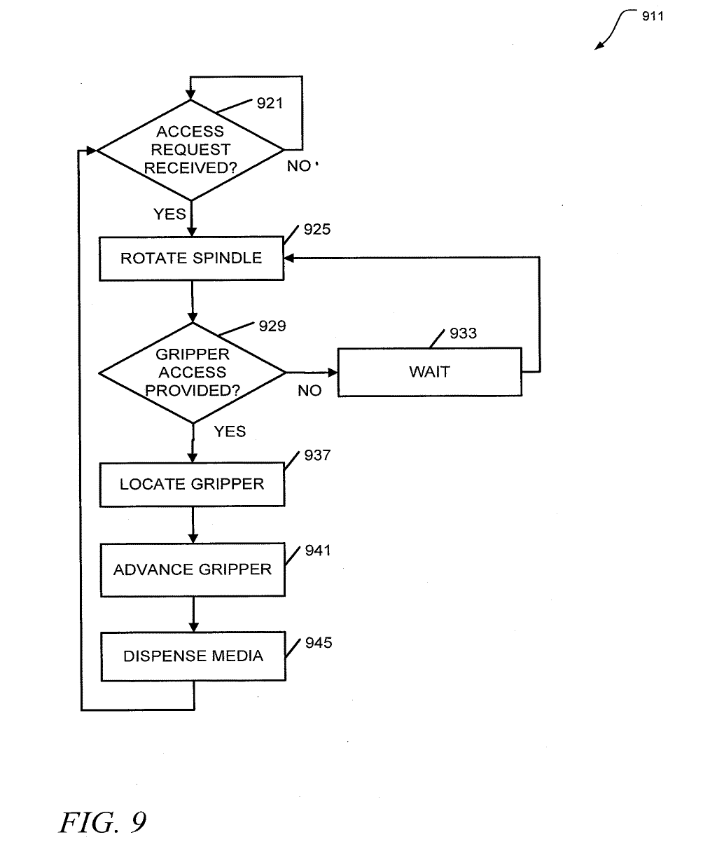

The apparatus 880 and system 800 may be implemented in a machine-accessible and readable medium that is operational over one or more networks 816. The networks 816 may be wired, wireless, or a combination of wired and wireless. The apparatus 880 and system 800 can be used to implement, among other things, the processing associated with the methods 911 of FIG. 9, described below. Modules may comprise hardware, software, and firmware, or any combination of these. Additional embodiments may be realized.

For example, a system 800 may comprise a server (e.g., node 802) and multiple apparatus 880 communicatively coupled to the server, each of the apparatus comprising one or more of the elements shown in FIGS. 1-7, and described above. The server may comprise a portion of a tangible storage media 130 inventory management system. The system 800 may comprise multiple user interface stations, each forming part of an apparatus 880, wherein each station can control the rotation of the spindle 222, and one gripper 120.

FIG. 9. is a flow diagram of methods 911 to manage access to tangible storage media, according to various embodiments of the invention. In some embodiments, a request to access one of the media is received, and the spindle is rotated to provide access to the selected one of the media along the media insertion axis by one of the grippers. If there is more than one request pending (e.g., multiple PODs are provided in a kiosk, and more than one consumer has requested that media be dispensed), the gripper(s) can then travel in the vertical direction and extend/retract to grip the media and extract it from the rack located in front of the gripper.

Thus, a method 911 of managing access to tangible storage media may begin at block 921 with receiving a request to access a selected one of a plurality of tangible storage media held in a plurality of substantially rectangular tangible storage media storage racks, each of the racks having first and second opposing sides substantially parallel to a media insertion axis of the rack in a horizontal plane. If desired, the activity at block 921 can include waiting until one or more requests to access media are received before proceeding to block 925.

The method 911 may continue on to block 925 with rotating a vertical spindle having a longitudinal axis substantially perpendicular to the horizontal plane and coupled to the plurality of racks with a corresponding plurality of arms having substantially equal length. The rotation is used to provide access to one or more grippers located to extract selected media along respective media insertion axes. The racks may be oriented as described previously, with respect to FIGS. 1-8.

In most embodiments, the generation of centrifugal force does not coincide with the media insertion axis, helping to prevent media cases from being thrown out of their holding racks as the carousel rotates. Thus, the activity at block 925 may comprise generating centrifugal force on the tangible storage media along a force axis, the force axis not being parallel to the media insertion axis in the horizontal plane.

The spindle may be rotated in increments of a circle to provide access to adjacent racks. Thus, the activity at block 925 may comprise rotating the vertical spindle about the longitudinal axis about 360 degrees divided by a number of the racks, to index the spindle from a first location providing tangible storage medium access to the gripper at the first one of the racks, to a second location providing tangible storage medium access to the gripper at the second one of the racks.

Grippers may move prior to movement of the spindle, at the same time the spindle moves, or after the spindle has stopped moving. In any case, the method 911 may include checking to determine whether gripper access has been provided, so that at least one of the grippers has access to a rack containing the selected tangible storage media at block 929. If access is not provided, the method 911 may include waiting at block 933 until access is provided by continued rotation of the spindle at block 925.

At some point during the process of gaining access to the selected tangible storage media, one or more grippers will be moved to a location directly opposite the location in the rack in which the selected medium resides. Grippers can be limited to two directions of travel in some embodiments. Thus, the method 911 may comprise locating the gripper to extract the selected one of the media at block 937 by moving the gripper in no more than two directions, which may be substantially orthogonal. For the purposes of this document, “substantially orthogonal” means that the directions are within 5 degrees of perpendicularity.

The gripper directions of travel may include the media insertion axis, and the vertical direction. Thus, a first one of the two directions may comprise the media insertion axis, and a second one of the two directions may comprise the travel axis (e.g., the Z axis) of the gripper that is substantially parallel to the longitudinal axis of the spindle. The travel axis may be defined by a vertical track to which the gripper is mounted. Once the gripper is located opposite the medium that has been selected, via rotation of the spindle and travel in the vertical (Z axis) direction, the method 911 may continue on to block 941 with advancing the gripper to access the selected one of the media.

After grasping the selected medium, the gripper may be retracted and operated to dispense the medium at block 945. The media may be dispensed to the consumer via a physical access port comprising part of a POD, and/or an access door of a kiosk.

The methods described herein do not have to be executed in the order described, or in any particular order. Moreover, various activities described with respect to the methods identified herein can be executed in repetitive, serial, or parallel fashion. The individual activities of the methods shown in FIG. 9 can also be combined with each other and/or substituted, one for another, in various ways. Information, including parameters, commands, operands, and other data, can be sent and received in the form of one or more carrier waves. The methods can be implemented in various devices, as well as in a computer-readable storage medium, where the methods are adapted to be executed by one or more processors. Thus, many other embodiments may be realized.

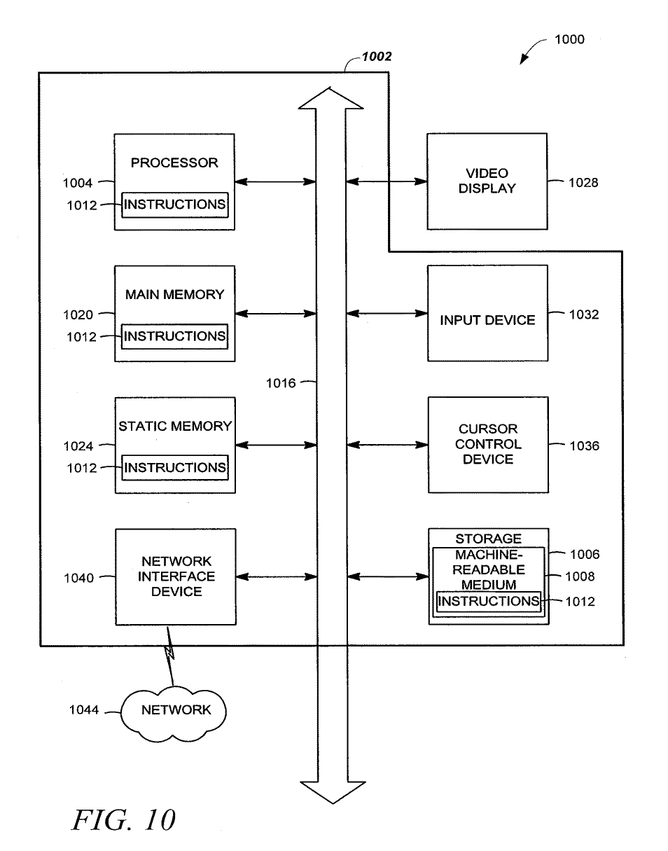

For example, FIG. 10 is a block diagram of an article of manufacture 1000, including a specific machine 1002, according to various embodiments of the invention. Upon reading and comprehending the content of this disclosure, one of ordinary skill in the art will understand the manner in which a software program can be launched from a computer-readable medium in a computer-based system to execute the functions defined in the software program.

One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those of ordinary skill in the art, such as application program interfaces or interprocess communication techniques, including remote procedure calls. The teachings of various embodiments are not limited to any particular programming language or environment. Thus, other embodiments may be realized.

For example, an article 1000 of manufacture, such as a computer, a memory system, a magnetic or optical disk, some other storage device, and/or any type of electronic device or system may include one or more processors 1004 coupled to a machine-readable medium 1008 such as a memory (e.g., removable storage media, as well as any memory including an electrical, optical, or electromagnetic conductor) having instructions 1012 stored thereon (e.g., computer program instructions), which when executed by the one or more processors 1004 result in the machine 1002 performing any of the actions described with respect to the methods, apparatus, and systems disclosed above.

The machine 1002 may take the form of a specific computer system having a processor 1004 coupled to a number of components directly, and/or using a bus 1016. Thus, the machine 1002 may be similar to or identical to the apparatus or systems shown in FIGS. 1-8.

Turning now to FIG. 10, it can be seen that components of the machine 1002 may include main memory 1020, static or non-volatile memory 1024, and mass storage 1006. Other components coupled to the processor 1004 may include an input device 1032, such as a keyboard, or a cursor control device 1036, such as a mouse. An output device 1028, such as a video display, may be located apart from the machine 1002 (as shown), or made as an integral part of the machine 1002.

A network interface device 1040 to couple the processor 1004 and other components to a network 1044 may also be coupled to the bus 1016. The instructions 1012 may be transmitted or received over the network 1044 via the network interface device 1040 utilizing any one of a number of well-known transfer protocols (e.g., HyperText Transfer Protocol). Any of these elements coupled to the bus 1016 may be absent, present singly, or present in plural numbers, depending on the specific embodiment to be realized.

The processor 1004, the memories 1020, 1024, and the storage device 1006 may each include instructions 1012 which, when executed, cause the machine 1002 to perform any one or more of the methods described herein. In some embodiments, the machine 1002 operates as a standalone device or may be connected (e.g., networked) to other machines. In a networked environment, the machine 1002 may operate in the capacity of a server or a client machine in server-client network environment, or as a peer machine in a peer-to-peer (or distributed) network environment.

The machine 1002 may comprise a personal computer (PC), a tablet PC, a set-top box (STB), a personal digital assistant (PDA), a cellular telephone, a web appliance, a network router, switch or bridge, server, client, or any specific machine capable of executing a set of instructions (sequential or otherwise) that direct actions to be taken by that machine to implement the methods and functions described herein. Further, while only a single machine 1002 is illustrated, the term “machine” shall also be taken to include any collection of machines that individually or jointly execute a set (or multiple sets) of instructions to perform any one or more of the methodologies discussed herein.

While the machine-readable medium 1008 is shown as a single medium, the term “machine-readable medium” should be taken to include a single medium or multiple media (e.g., a centralized or distributed database), and/or associated caches and servers, and or a variety of storage media, such as the registers of the processor 1004, memories 1020, 1024, and the storage device 1006 that store the one or more sets of instructions 1012. The term “machine-readable medium” shall also be taken to include any medium that is capable of storing, encoding or carrying a set of instructions for execution by the machine and that cause the machine 1002 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

Various embodiments may be implemented as a stand-alone application (e.g., without any network capabilities), a client-server application or a peer-to-peer (or distributed) application. Embodiments may also, for example, be deployed by Software-as-a-Service (SaaS), an Application Service Provider (ASP), or utility computing providers, in addition to being sold or licensed via traditional channels.

Implementing the apparatus, systems, and methods described herein may operate to provide new options for managing access to tangible storage media, such as optical discs dispensed via kiosks. Enhanced dispensing efficiency and increased consumer satisfaction may result.

This Detailed Description is illustrative, and not restrictive. Many other embodiments will be apparent to those of ordinary skill in the art upon reviewing this disclosure. The scope of embodiments should therefore be determined with reference to the appended claims, along with the full scope of equivalents to which such claims are entitled.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method, comprising:
receiving a request to access a selected one of a plurality of tangible storage media held in a plurality of substantially rectangular tangible storage media storage racks, each of the racks having first and second opposing sides substantially parallel to a media insertion axis of the rack in a horizontal plane; and
rotating a vertical spindle having a longitudinal axis substantially perpendicular to the horizontal plane and coupled to the plurality of racks with a corresponding plurality of arms having substantially equal length, to provide access to a gripper located to extract the selected one along the media insertion axis, wherein a side axis coinciding with the first opposing side of a first one of the racks intersects the second opposing side of a second one of the racks, the first one of the racks and the second one of the racks comprising an adjacent pair of racks.

2. The method of claim 1, further comprising:
locating the gripper to extract the selected one by moving the gripper in no more than two substantially orthogonal directions.

3. The method of claim 2, wherein a first one of the directions comprises the media insertion axis, and a second one of the directions comprises a travel axis of the gripper that is substantially parallel to the longitudinal axis.

4. The method of claim 1, wherein the rotating includes rotating the vertical spindle about the longitudinal axis about 360 degrees divided by a number of the racks, to index the spindle from a first location providing tangible storage medium access to the gripper at the first one of the racks, to a second location providing tangible storage medium access to the gripper at the second one of the racks, further comprising:
advancing the gripper to access the selected one.

5. The method of claim 1, wherein the rotating comprises:
generating centrifugal force on the tangible storage media along a force axis, the force axis not being parallel to the media insertion axis in the horizontal plane.

6. An apparatus, comprising:
a plurality of substantially rectangular tangible storage media storage racks, each of the racks having first and second opposing sides substantially parallel to a media insertion axis of the rack in a horizontal plane; and
a vertical spindle having a longitudinal axis substantially perpendicular to the horizontal plane and coupled to the plurality of racks with a corresponding plurality of arms having substantially equal length, wherein a side axis coincident with the first opposing side of a first one of the racks intersects the second opposing side of a second one of the racks, the first one of the racks and the second one of the racks comprising an adjacent pair of racks.

7. The apparatus of claim 6, wherein the racks are configured to hold multiple ones of tangible storage media housed in substantially similar individual rectangular transport cases.

8. The apparatus of claim 6, wherein an axis of centrifugal force defined by rotation of the vertical spindle and the horizontal plane is not collinear with the media insertion axis.

9. The apparatus of claim 6, wherein each one of the racks is rigidly attached to a corresponding one of the arms.

10. The apparatus of claim 6, further comprising:
multiple grippers having a travel direction substantially parallel to the longitudinal axis, wherein the grippers are configured to grasp individual ones of tangible storage media held in the racks.

11. The apparatus of claim 10, wherein each of the grippers, when retracted, can move in the travel direction at substantially the same time, in conjunction with continuous rotation of the spindle about the longitudinal axis.

12. The apparatus of claim 10, further comprising:
multiple user interface stations, wherein each one of the user interface stations is operable to control one of the grippers to grasp the individual ones of the tangible storage media when operational power is applied to the user interface stations and the grippers.

13. The apparatus of claim 10, further comprising:
multiple access doors attached to a housing surrounding the racks, wherein each one of the access doors corresponds to one of the grippers and provides a port with physical access to the individual ones of the tangible storage media that have been extracted by the corresponding one of the grippers.

14. The apparatus of claim 10, wherein all of the grippers can be located to substantially simultaneously grasp individual ones of tangible storage media held in the racks facing individual ones of the grippers, when the spindle is not rotating.

15. The apparatus of claim 6, wherein each of the racks is fixedly spaced apart from adjacent racks by approximately a same distance in the horizontal plane.

16. A system, comprising:
a server; and
multiple apparatus communicatively coupled to the server, each of the apparatus comprising a plurality of substantially rectangular tangible storage media storage racks, each of the racks having first and second opposing sides substantially parallel to a media insertion axis of the rack in a horizontal plane, each of the apparatus further comprising a vertical spindle having a longitudinal axis substantially perpendicular to the horizontal plane and coupled to the plurality of racks with a corresponding plurality of arms having substantially equal length, wherein a side axis coincident with the first opposing side of a first one of the racks intersects the second opposing side of a second one of the racks, the first one of the racks and the second one of the racks comprising an adjacent pair of racks.

17. The system of claim 16, wherein the server comprises a portion of a tangible storage media inventory management system.

18. The system of claim 16, wherein each of the apparatus further comprises:
multiple user interface stations, wherein each one of the user interface stations is operable to control rotation of the vertical spindle and a single gripper to grasp individual ones of tangible storage media stored in the racks when operational power is applied to the user interface stations and the grippers.

19. The system of claim 16, wherein each of the apparatus further comprises:
a transmission module to transmit inventory status to the server, the inventory status identifying tangible storage media removed from the racks, or replaced in the racks.

20. The system of claim 16, wherein the apparatus is housed in a kiosk configured to provide physical access via multiple ports to selected tangible storage media held in the racks and dispensed therefrom in return for monetary consideration.
